(19) United States
(12) Patent Application Publication
(10) Pub. No.: US 2026/0097798 A1
(43) Pub. Date: Apr. 9, 2026

(54) EQUIPMENT TRANSPORT APPARATUS

(71) Applicants: Karl J. Niemela, Chassell, MI (US); Konrad M. Niemela, Bryant, SD (US); Teras Enterprises Inc., Hayti, SD (US)

(72) Inventors: Logan Daniel Aho, Greer, SC (US); Maximilian James Aho, Kingsbury, TX (US)

(73) Assignees: Karl J. Niemela, Chassell, MI (US); Konrad M. Niemela, Bryant, SD (US); Teras Enterprises Inc., Hayti, SD (US)

(21) Appl. No.: 19/417,815

(22) Filed: Dec. 12, 2025

Related U.S. Application Data
(63) Continuation of application No. 18/742,014, filed on Jun. 13, 2024.
(60) Provisional application No. 63/600,458, filed on Nov. 17, 2023.

(51) Int. Cl. B62B 1/12

(52) U.S. Cl. CPC B62B 1/12; B62B 2301/05; B62B 2301/14

(57) ABSTRACT

An equipment transport apparatus is designed to facilitate the transportation or movement of a piece of equipment by a single user. The equipment transport apparatus includes a coupling block configured for being attached to the piece of equipment in a fixed position, a wheel assembly rotatably coupled to the coupling block, and a position selector coupled to the wheel assembly. The wheel assembly is configured to rotate relative to the coupling block between a deployed configuration and a stowed configuration. The coupling block has a wheel positioning flange having a first opening and a second opening and the position selector is configured to engage with the first opening when the wheel assembly is in the deployed configuration and with the second opening when the wheel assembly is in the stowed configuration. The apparatus provides a safer, more efficient, and user-friendly solution to the challenges associated with equipment transportation.

### CROSS-REFERENCE TO RELATED APPLICATIONS

This application is a continuation of U.S. patent application Ser. No. 18/742,014, entitled “EQUIPMENT TRANSPORT APPARATUS,” filed on Jun. 13, 2024, which claims priority to U.S. Provisional Patent Application No. 63/600,458 filed on Nov. 17, 2023, entitled “Equipment Transport Apparatus,” the contents of which are incorporated herein by reference.

### BACKGROUND

### Field of Art

This invention relates to the field of transporting and/or moving heavy and/or bulky equipment.

### Discussion of the State of the Art

The field of material handling, particularly the transportation and lifting of heavy equipment, has long been fraught with challenges. These challenges are primarily centered around the physical strain and risk of injury to the individuals involved in these tasks. The manual lifting and transportation of heavy equipment often requires the efforts of two or more individuals, which not only increases the risk of injury but also consumes a significant amount of time and resources, thereby reducing overall operational efficiency.

Injuries associated with manual lifting and transportation of heavy equipment are often severe, affecting various parts of the body including the back, legs, arms, hips, feet, hands, neck and abdominal muscles. These injuries can result from a single traumatic event, such as lifting a heavy object incorrectly, or can develop over time due to repetitive strain on certain muscle groups. The risk of such injuries is particularly high in industries that frequently handle heavy equipment, such as construction, manufacturing, and logistics.

The time-consuming nature of manual lifting and transportation also poses a significant problem. The requirement for multiple users to lift and transport heavy equipment not only slows down the process but also increases labor costs. This lack of efficiency can have a detrimental impact on the productivity and profitability of businesses that regularly handle heavy equipment.

Efforts have been made to address these problems through the development of various apparatuses designed to lift and transport heavy equipment. However, these solutions have been largely unsuccessful. Many of these apparatuses require the use of numerous movable objects, which can complicate their operation and maintenance. Furthermore, these apparatuses often fail to adequately mitigate the risk of injury associated with lifting and transporting heavy equipment. Therefore, there is a clear and pressing need for a more effective solution to these longstanding problems in the field of material handling.

### SUMMARY

The present invention pertains to an equipment transport apparatus that enables a single user to transport or move a piece of heavy and/or bulky equipment across or around a job site without the need for assistance. This invention addresses the prevalent issues of injury risks and inefficiencies associated with the manual lifting and transportation of heavy equipment.

The equipment transport apparatus of the present invention incorporates a fixed wheel system that allows for easy and safe transportation of heavy equipment. The strategic placement of the wheel system ensures proper balance and even distribution of the equipment's weight, significantly reducing the risk of injury as the user only needs to push or pull the equipment. This invention effectively eliminates the need for multiple users to transport or move the equipment, resulting in significant savings on labor costs.

Furthermore, the equipment transport apparatus provides additional benefits in terms of maintenance and parts replacement. The design of the apparatus is user-friendly and straightforward, making it easy to maintain and replace parts when necessary. This simplicity of design also contributes to the overall cost-effectiveness of the apparatus.

In one example, the present invention is an equipment transport apparatus configured for being attached to a piece of equipment and for facilitating moving the piece of equipment between locations. The equipment transport apparatus includes a coupling block configured for being attached to the piece of equipment in a fixed position. The coupling block has a wheel positioning flange having a first opening and a second opening. The equipment transport apparatus further includes a wheel assembly rotatably coupled to the coupling block such that the wheel assembly is configured to rotate relative to the coupling block between a deployed configuration and a stowed configuration. Still further, the equipment transport apparatus includes a position selector coupled to the wheel assembly and configured to engage with the first opening in the coupling block when the wheel assembly is in the deployed configuration and with the second opening in the coupling block when the wheel assembly is in the stowed configuration. The position selector may be a quick release pin.

The wheel assembly may include a shaft having a distal end, a proximal end, and a longitudinal axis extending therebetween. The wheel assembly may further include a wheel rotatably coupled to an axle on the distal end of the shaft, and an arm fixedly coupled to the proximal end of the shaft, wherein the arm extends perpendicular to the longitudinal axis of the shaft. The arm may include a first axle opening and a second axle opening aligned with the first axle opening. The coupling block may include a cooperating first axle opening and a cooperating second axle opening, and the wheel assembly may be attached to the coupling block with a pivot rod that passes through the first axle opening, the cooperating first axle opening, the second axle opening, and the second cooperating axle opening. The wheel assembly may be configured to rotate around the pivot rod.

The coupling block may include a base plate having a first side and a second side opposite of the first side, and a wheel connector tab perpendicular to the base plate and coupled to the first side of the base plate. The wheel positioning flange may be perpendicular to the base plate and coupled to the second side of the base plate. The base plate may have attachment openings configured for having attachment members pass therethrough for connecting the coupling block to the piece of equipment. The wheel positioning flange may further include a first axle opening and the wheel connector tab may include a second axle opening aligned with the first axle opening. The wheel assembly may be configured to rotate about a longitudinal axis that passes through the first axle opening and the second axle opening. The wheel assembly may be coupled to the coupling block with a pivot rod that passes through the first and second axle openings. The wheel assembly may be configured to rotate relative to the pivot rod.

In summary, the equipment transport apparatus of the present invention provides a safer, more efficient, and cost-effective solution to the challenges associated with the manual lifting and transportation of heavy equipment. The equipment transport apparatus significantly reduces the risk of injury, increases operational efficiency, and offers easy maintenance, making it an ideal solution for industries that frequently handle heavy equipment.

### BRIEF DESCRIPTION OF THE DRAWING FIGURES

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1A is a perspective view of a piece of equipment having two equipment transport apparatuses attached thereto in a deployed configuration, in accordance with an embodiment of the invention.

FIG. 1B is a perspective view of the equipment transport apparatus in a stowed configuration, in accordance with an embodiment of the invention.

FIG. 1C is a close up view of the equipment transport apparatus in a deployed configuration, in accordance with an embodiment of the invention.

FIG. 1D is a plan view of the connection between the equipment transport apparatus and the piece of equipment, in accordance with an embodiment of the invention.

FIG. 2A is a perspective view of the equipment transport apparatus, in accordance with an embodiment of the invention.

FIGS. 2B, 2C, and 2D are side, front and rear views, respectively, of the equipment transport apparatus in a stowed configuration, in accordance with an embodiment of the invention.

FIG. 3 is an exploded view of components of the equipment transport apparatus, in accordance with an embodiment of the invention.

### DETAILED DESCRIPTION OF EMBODIMENTS

The present invention is for an equipment transport apparatus having a deployed position and a stowed position. The equipment transport apparatus may be attached to any piece of equipment to facilitate moving the equipment between desired locations. In one example, the equipment transport apparatus is attached to a concrete power trowel.

The invention is described by reference to various elements herein. It should be noted, however, that although the various elements of the inventive apparatus are described separately below, the elements need not necessarily be separate. The various embodiments may be interconnected and may be cut out of a singular block or mold. The variety of different ways of forming an inventive apparatus, in accordance with the disclosure herein, may be varied without departing from the scope of the invention.

Generally, one or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices and parts that are connected to each other need not be in continuous connection with each other, unless expressly specified otherwise. In addition, devices and parts that are connected with each other may be connected directly or indirectly through one or more connection means or intermediaries.

A description of an aspect with several components in connection with each other does not imply that all such components are required. To the contrary, a variety of optional components may be described to illustrate a wide variety of possible embodiments and in order to more fully illustrate one or more embodiments. Similarly, although process steps, method steps, or the like may be described in a sequential order, such processes and methods may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, or method is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Alternate implementations are included within the scope of various embodiments in which, for example, functions may be executed out of order from that shown or discussed, including substantially concurrently or in reverse order, depending on the functionality involved, as would be understood by those having ordinary skill in the art.

### Apparatus

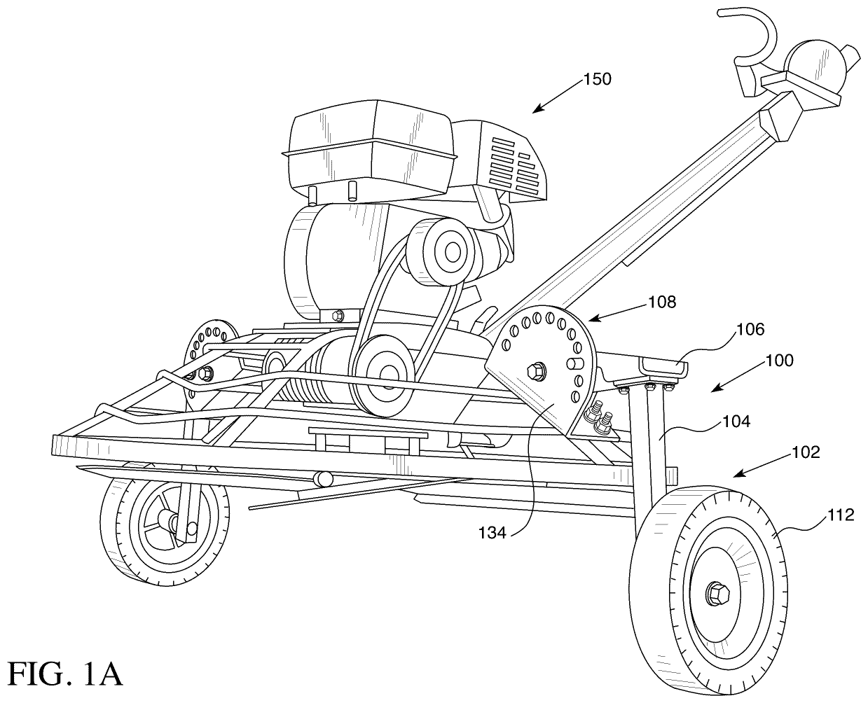

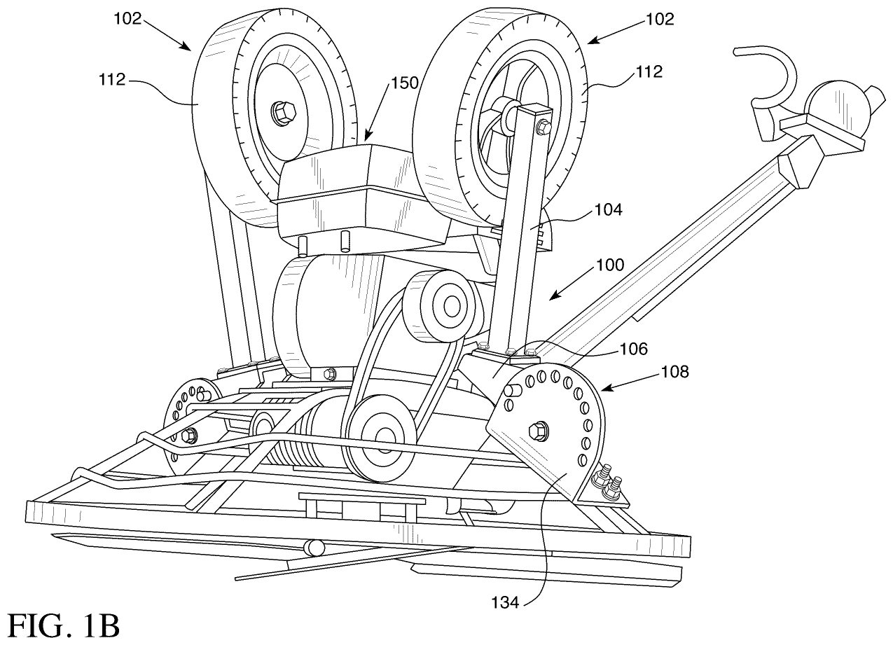

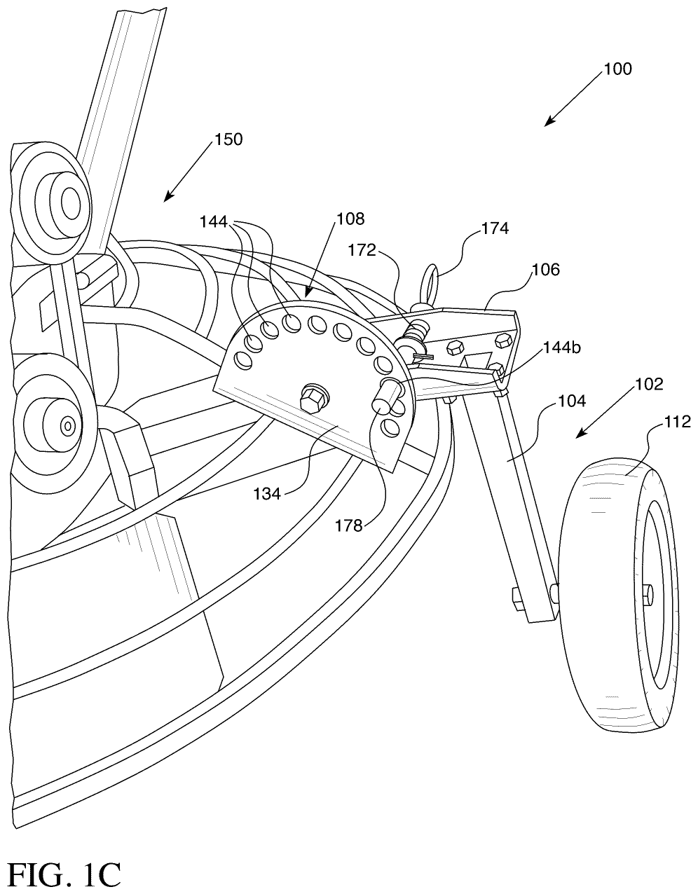

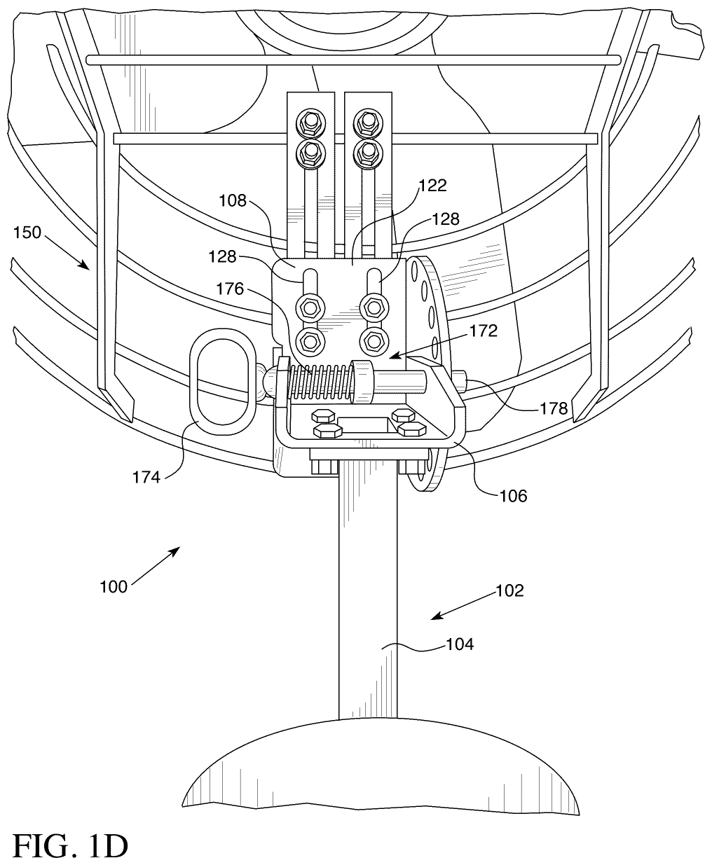

The equipment transport apparatus 100 of the present invention is configured for being attached to a piece of equipment 150 that is large, heavy, bulky, or otherwise difficult to move from one location to another. The apparatus 100 enables the equipment 150 to be moved easily and conveniently with little or no lifting. In the example shown in FIGS. 1A-1D, the equipment transport apparatus 100 is removably attached to a concrete power trowel 150. However, the apparatus 100 is not limited to being used with a concrete power trowel 150, and may alternatively be attached to any other piece of equipment that may need to be moved from one location to another.

The equipment transport apparatus 100 has a deployed configuration, shown in FIGS. 1A and 1C, and a stowed configuration, shown in FIG. 1B. The transport apparatus 100 allows a user to quickly deploy the wheels 112 for non-use transportation (e.g., while moving the equipment to or from a worksite while the equipment is not in use). The transport apparatus 100 is simple to operate, inexpensive to produce, easy to maintain, and requires little to no training.

In the deployed configuration, the wheels 112 of the apparatus 100 are in the down position and are touching the ground so that the equipment 150 is supported in a raised position for wheeled movement and can be easily pushed or pulled from one location to another. The equipment 150 is supported above the ground by the wheels 112 when the apparatus 100 is in the deployed configuration. In this manner, the wheels 112 support the load for transportation. Elevating the equipment 150 using the apparatus 100 is also beneficial for accessing the underside of the equipment 150 for cleaning, maintenance, etc.

In the stowed configuration, the wheels 112 are in a lifted position that does not interfere with the normal operation of the equipment 150. Further, the apparatus 100 is positioned within the footprint of the equipment 150 when the apparatus 100 is in the stowed configuration.

Notably, the equipment transport apparatus 100 remains coupled to the equipment 150 in both the deployed configuration and the stowed configuration. This configuration provides the user with constant access to the apparatus 100, eliminating the need to search for loose wheel systems. In the example depicted in FIGS. 1A-1D, the piece of equipment 150 has a pair of transport apparatuses 100 coupled thereto. The center of gravity of the equipment 150 is aligned with the wheels 112 to provide a carefully balanced and easily maneuvered system. However, the invention is not limited to being used in a pair and it will be appreciated that 1, 3, 4, or more apparatuses may be coupled to a piece of equipment, depending on the size and arrangement of the equipment. Regardless of how many transport apparatuses 100 are attached to a piece of equipment, the wheels 112 of each apparatus 100 are operated independently of each other, which may be advantageous for use on uneven ground surfaces.

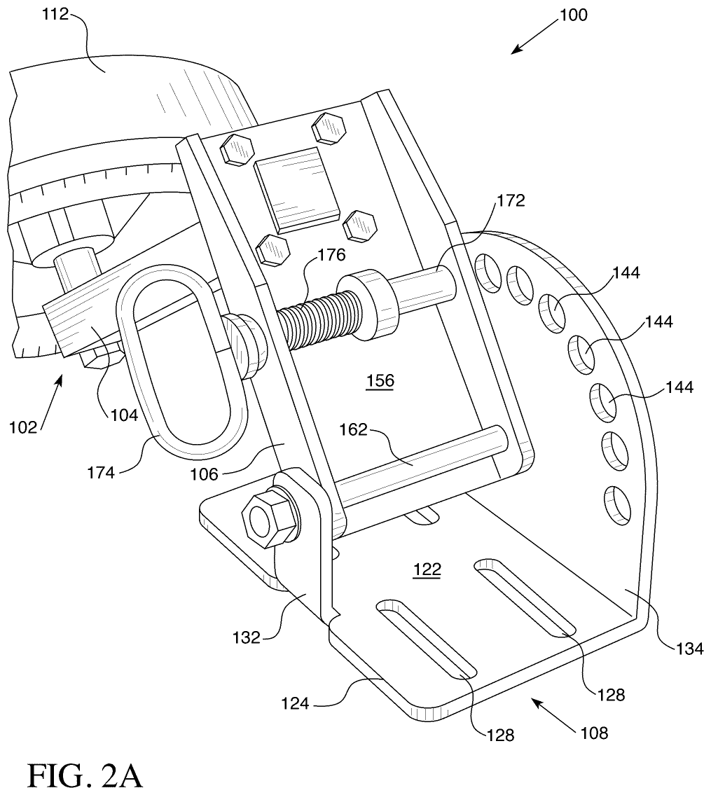

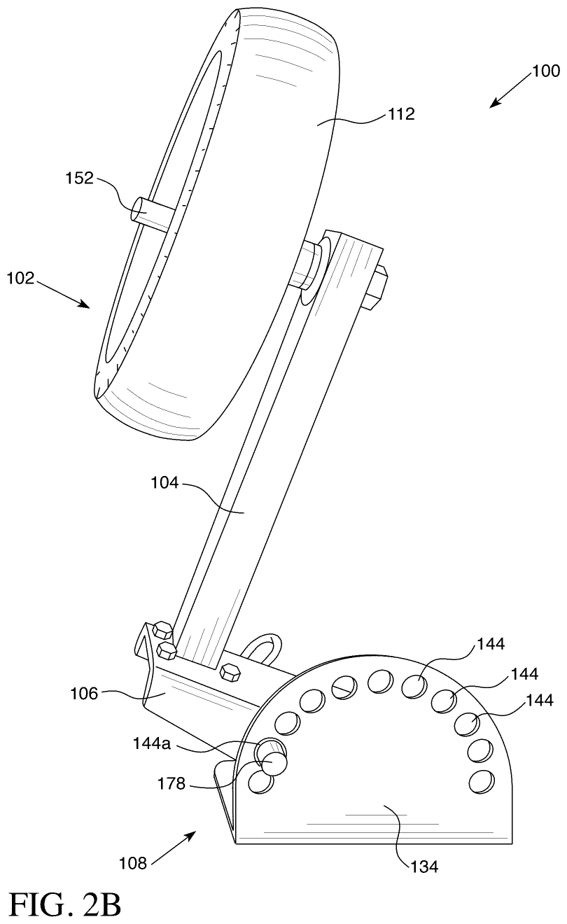

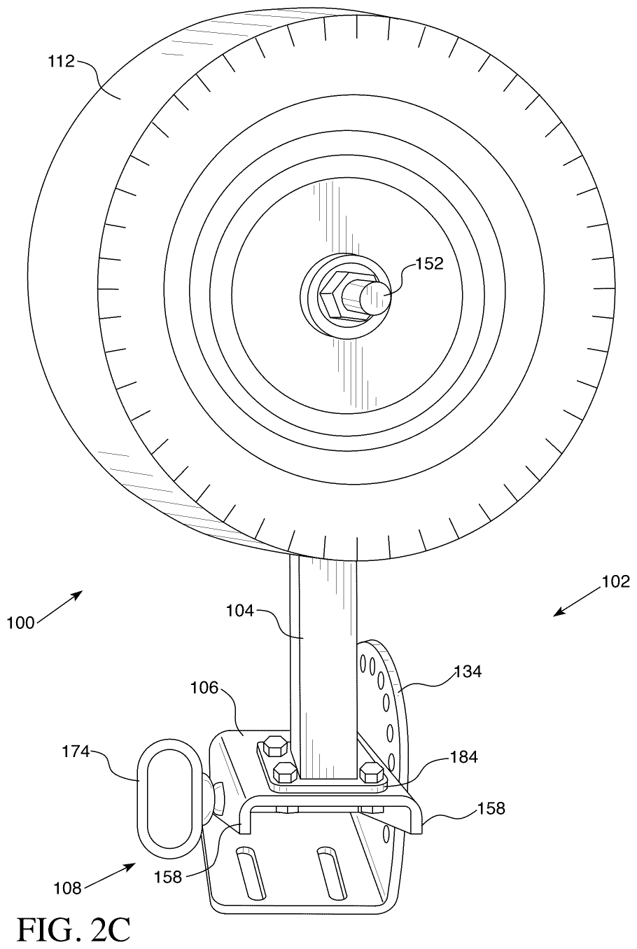

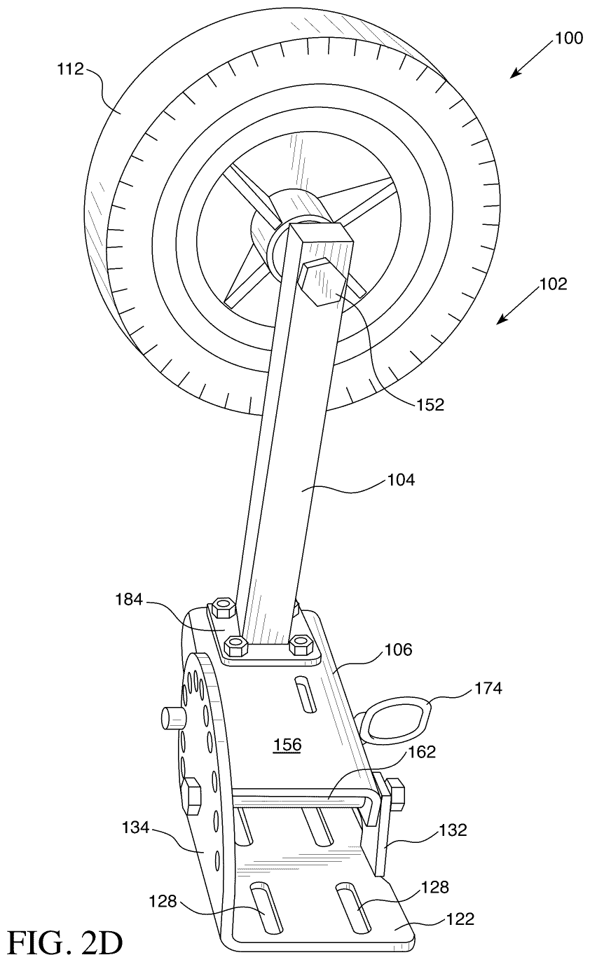

The equipment transport apparatus 100 is described in more detail with reference to FIGS. 2A-2D. The transport apparatus 100 includes a wheel assembly 102 that is hingedly coupled to a coupling block 108. The coupling block 108 is configured for being attached to the equipment 150 and for retaining the wheel assembly 102 in the desired position (e.g. the deployed position or the stowed position). The wheel assembly 102 includes a wheel 112 that is attached to a shaft 104. The shaft 104 is coupled to an arm 106, and the arm 106 is hingedly attached to the coupling block 108. The coupling block 108 is coupled to the piece of equipment 150.

The coupling block 108 is designed to be securely affixed to the piece of equipment 150, serving as a sturdy platform for the hinged wheel assembly 102. This design allows the wheel assembly 102 to rotate between a transport position and a storage position, providing versatility in usage.

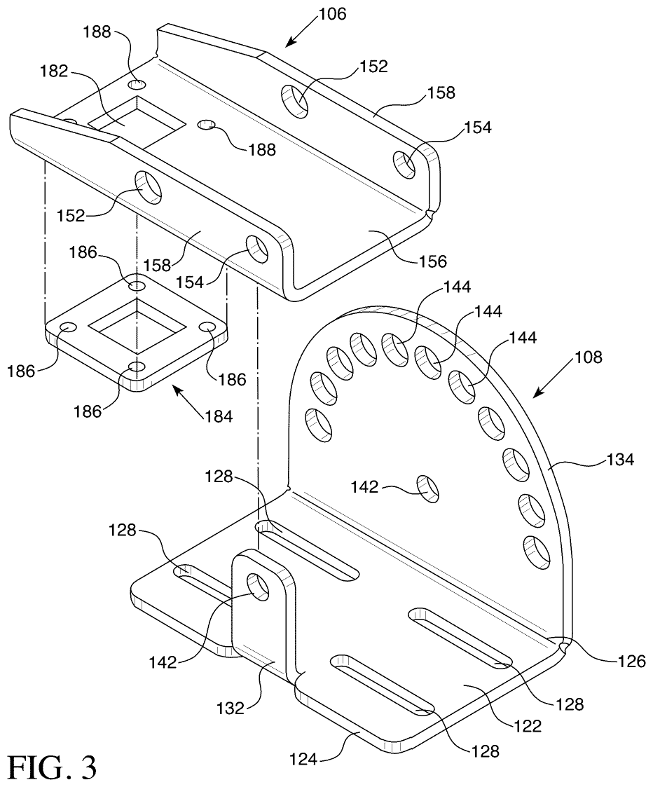

As shown in FIGS. 2A and 3, The coupling block 108 includes a base plate 122 having a first side 124 and a second side 126 opposite of the first side 124. The base plate 122 also includes slots 128 cut into its structure, which serve as convenient attachment points. These slots 128 are strategically designed to enable the user to find the correct location, which aligns with the attachment point on the piece of equipment 150, for the apparatus 100 to be mounted to the piece of equipment 150. These slots 128 are designed to accommodate U-bolts or square bolts, enabling the coupling block 108 to be removably affixed to the equipment. For example, the base plate 122 may be coupled to the piece of equipment 150 using screws, nuts, bolts, washers, or the like, that pass through the slots 128 and engage with an attachment point on the equipment 150, as depicted in FIG. 1D. However, apparatus 100 is not limited to this attachment method. In other examples, the base plate 122 may be coupled to the equipment 150 by welding, adhesive, magnets, or other similar attachment mechanisms. Regardless of the attachment mechanism used to attach the coupling block 108 to the equipment 150, the position of the coupling block 108 relative to the equipment 150 is fixed.

The coupling block 108 further includes a wheel connector tab 132 and a wheel positioning flange 134. The wheel connector tab 132 is attached to the first side 124 of the base plate 122 and extends perpendicularly to the base plate 122. The wheel positioning flange 134 is attached to the second side 126 of the base plate 122 and positioned perpendicular to the base plate 122. The wheel connector tab 132 and the wheel positioning flange 134 are thus parallel to each other.

As shown in FIG. 3, the wheel connector tab 132 and the wheel positioning flange 134 each include an axle opening 142. The axle openings 142 are aligned with each other, which allow for bolts to pass through and function as a hinge point for the wheel assembly 102 to be attached.

The wheel positioning flange 134 includes a plurality of wheel positioning openings 144. The wheel positioning flange 134 has at least two wheel positioning openings 144, but may have any desired number of wheel positioning openings 144, depending on the desired positions of the wheel assembly 102 relative to the coupling block 108.

The coupling block 108 may be fabricated from a variety of high-strength materials, including but not limited to metal, steel, carbon fiber, and cast iron. This allows for flexibility in manufacturing and ensures the coupling block 108 can withstand the rigors of use.

The wheel assembly 102 includes a wheel 112 that is coupled to the distal end of the shaft 104 in a manner that allows the wheel 112 to rotate relative to the shaft 104. In this example, the wheel 112 is coupled to an axle 152 that is coupled to the distal end of the shaft 104. Although only one wheel 112 is depicted, the apparatus 100 is not limited to having one wheel. For example, a pair of wheels may be coupled to the axle 152, with one wheel disposed on either side of the shaft 104.

The proximal end of the shaft 104 is coupled to an arm 106. Referring now to FIG. 3, the arm 106 includes a base plate 156 and flanges 158 that are perpendicular to, and coupled to opposite sides of, the base plate 156. Each one of the flanges 158 includes a wheel positioning opening 152 and a connector opening 154. The wheel positioning openings 152 are aligned with each other and the connector openings 154 are aligned with each other.

The arm 106 is designed to connect to the coupling block 108. In particular, the connector openings 154 in the arm 106 are designed to accommodate a nut, washer and bolt assembly. This bolting assembly serves to connect the arm 106 to the coupling block 108, ensuring a secure and stable connection between the two components.

As shown in FIGS. 2A and 2D, the arm 106 is coupled to the coupling block 108 with an elongated bolt, or a pivot rod 162, that passes through the connector openings 154 in the arm 106 and the axle openings 142 in the coupling block 108. The arm 106 pivots around the longitudinal axis of the pivot rod 162.

The mechanism for changing the position of the wheel assembly 102 will be described in more detail with reference to FIG. 2A. The wheel assembly 102 includes a position selector 172 that is used to adjust the position of the wheel assembly 102 relative to the coupling block 108. In one example, the position selector 172 is a spring loaded quick release pin. However, other position selector mechanisms may alternatively be used to adjust the position of the wheel assembly 102. For example, the position selector may be a clip, a clamp, a button, or the like.

The position selector 172 is configured to engage with the coupling block 108 in a plurality of positions provided by the wheel positioning openings 144 in the coupling block 108. The position selector 172 has a shaft that is disposed in the wheel positioning openings 152 in the arm 106. The position selector 172 further includes a distal end 178, a handle 174 on the proximal end of the shaft, and a compression spring 176 that is biased to keep the position selector 172 in the extended position so that the distal end 178 is engaged in one of the wheel positioning openings 144 in the coupling block 108.

In order to adjust the position of the wheel assembly 102 relative to the coupling block 108, the handle 174 is used to pull the distal end 178 of the quick release pin 172 out of the wheel positioning opening 144. The quick release pin 172 is spring-biased to be in the extended position, so the user must pull the quick release pin 172 with enough force to overcome the force of the compression spring 176. The wheel assembly 102 is then rotated relative to the coupling block 108 until the wheel assembly 102 is in the desired position. Then quick release pin 172 is then released so that the distal end 178 of the quick release pin 172 is inserted into another one of the wheel positioning openings 144 to thereby hold the wheel assembly 102 in the desired position. As shown in FIG. 2B, the distal end 178 of the position selector 172 protrudes into a first wheel positioning opening 144a when the wheel assembly 102 is in the stowed configuration. As shown in FIG. 1C, the distal end 178 of the position selector 172 protrudes into a second wheel positioning opening 144b when the wheel assembly 102 is in the deployed configuration. As such, the coupling block 108 may only have two wheel positioning openings 144 and is not required to have a plurality of wheel positioning openings 144. That is, the coupling block 108 has at least two wheel positioning openings 144, but may have 3, 4, 5, 6, 7, 8, or more wheel positioning openings, depending on the desired positions of the wheel assembly 102.

The arm 106 further includes a shaft connection point 182 (shown in FIG. 3) to which the shaft 104 is attached. This design facilitates easy replacement of the leg assembly if it becomes damaged, enhancing the longevity and maintenance-friendly nature of the apparatus 100.

The apparatus 100 may further include a ringstep 184 that is configured to be welded (or otherwise permanently affixed) to the proximal end of the shaft 104. This welding allows the leg assembly to be securely attached to the arm 106, forming a robust and reliable connection. The ringstep 184 features four drilled holes 186 (shown in FIG. 3), which accommodate a bolt and nut assembly, enabling easy removal of the ringstep 184 that is welded to the shaft 104. In particular, as shown in FIG. 3, the arm 106 includes four coordinating holes 188 for facilitating connection between the ringstep 184 and the arm 106

This integration of the ringstep 184 into the wheel assembly 102 allows the user to replace or remove the entire shaft 104 and wheel 112 assembly as needed, enhancing the versatility and maintainability of the apparatus 100. The ringstep 184, once welded to the shaft 104, is secured to the arm 106 using four bolts. The arm 106 with the shaft 104 coupled thereto is subsequently attached to the coupling block 108. The coupling block 108 is then affixed to the piece of equipment 150, completing the assembly process.

As an alternative, in some embodiments, the shaft 104 could be directly welded to the arm 106, bypassing the need for a ringstep 184. This alternative could simplify the assembly process, although it may limit the flexibility offered by the removable ringstep design. In another alternative, the shaft 104 and ringstep 184 are manufactured as a single, unitary piece.

The shaft 104 is configured to be attached to an axle and wheel 112. The shaft 104 thus supports the equipment 150, which requires wheels for transportation across or around a jobsite. The shaft 104 can be fabricated from a variety of high-strength materials, including but not limited to metal, steel, carbon fiber, and cast iron.

By housing the axle and wheel assembly, the shaft 104 enables the equipment 150 to be transported across or around a jobsite. The design of the shaft 104, in conjunction with the ringstep 184 and arm 106, allows the user to rotate the wheel assembly 102 into either a transport mode or a storage mode.

### ADDITIONAL CONSIDERATIONS

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. An equipment transport apparatus configured for being attached to a piece of equipment and for facilitating moving the piece of equipment between locations, wherein the equipment transport apparatus comprises:
a coupling block configured for being attached to the piece of equipment in a fixed position, wherein the coupling block comprises a wheel positioning flange having a first opening and a second opening;
a wheel assembly rotatably coupled to the coupling block such that the wheel assembly is configured to rotate relative to the coupling block between a deployed configuration and a stowed configuration; and
a position selector coupled to the wheel assembly and configured to engage with the first opening in the coupling block when the wheel assembly is in the deployed configuration and with the second opening in the coupling block when the wheel assembly is in the stowed configuration.

2. The equipment transport apparatus of claim 1, wherein the wheel assembly comprises:
a shaft having a distal end, a proximal end, and a longitudinal axis extending therebetween;
a wheel rotatably coupled to an axle on the distal end of the shaft; and
an arm fixedly coupled to the proximal end of the shaft, wherein the arm extends perpendicular to the longitudinal axis of the shaft.

3. The equipment transport apparatus of claim 1, wherein the coupling block comprises:
a base plate having a first side and a second side opposite of the first side; and
a wheel connector tab perpendicular to the base plate and coupled to the first side of the base plate,
wherein the wheel positioning flange is perpendicular to the base plate and coupled to the second side of the base plate.

4. The equipment transport apparatus of claim 3, wherein the base plate comprises attachment openings configured for having attachment members pass therethrough for connecting the coupling block to the piece of equipment.

5. The equipment transport apparatus of claim 3, wherein the wheel positioning flange further comprises a first axle opening and the wheel connector tab comprises a second axle opening aligned with the first axle opening, wherein the wheel assembly is configured to rotate about a longitudinal axis that passes through the first axle opening and the second axle opening.

6. The equipment transport apparatus of claim 1, wherein the position selector comprises a quick release pin.

7. The equipment transport apparatus of claim 5, wherein the wheel assembly is coupled to the coupling block with a pivot rod that passes through the first and second axle openings, and wherein the wheel assembly is configured to rotate relative to the pivot rod.

8. The equipment transport apparatus of claim 2, wherein the arm comprises a first axle opening and a second axle opening aligned with the first axle opening, wherein the coupling block comprises a cooperating first axle opening and a cooperating second axle opening, and wherein the wheel assembly is attached to the coupling block with a pivot rod that passes through the first axle opening, the cooperating first axle opening, the second axle opening, and the second cooperating axle opening, and wherein the wheel assembly is configured to rotate around the pivot rod.
